(19) United States
(12) Patent Application Publication
(10) Pub. No.: US 2026/0195000 A1
(43) Pub. Date: Jul. 9, 2026

(54) Methods and Systems for Integrating Display Driving and Touch Sensing in In-Cell Panel Applications

(71) Applicant: PARADE TECHNOLOGIES, LTD., San Jose, CA (US)

(72) Inventor: Ian Kennedy, Glenville (IR)

(21) Appl. No.: 19/012,691

(22) Filed: Jan. 7, 2025

(51) Int. Cl. G06F 3/041; G02F 1/1333; G02F 1/1362; G06F 3/044

(52) U.S. Cl. CPC G06F 3/0412; G02F 1/13338; G02F 1/136286; G06F 3/04164; G06F 3/04184; G06F 3/0442; G06F 2203/04107

(57) ABSTRACT

This application relates to accessing display pixels and touch sensors in touch displays. An electronic device includes multiple display electrodes and a common electrode. The electronic device includes a display pixel array with a set of display pixels. Each display pixel of the set of display pixels is disposed between a respective display electrode and the common electrode. The common electrode is configured to provide touch sensing capabilities. The electronic device includes a set of source pins disposed in proximity to one or more edges of the display pixel array. Each respective source pin is configured to drive a distinct column of display electrodes of the plurality of display electrodes while the electronic device is in a display driving state. A subset of the same set of source pins is configured to be electronically coupled to the common electrode while the electronic device is in a touch sensing state.

### TECHNICAL FIELD

The disclosed implementations relate generally to display technology, including but not limited to methods, systems, devices, and interfaces for integrating display driving and touch sensing in in-cell display panels (e.g., touch displays).

### BACKGROUND

Touch screens that utilize capacitive sense arrays are widely applied in today's industrial and consumer product markets. Capacitive sense arrays can be found in cellular phones, GPS devices, set-top boxes, cameras, computer screens, MP3 players, digital tablets, and the like, replacing mechanical buttons, knobs, and other conventional user interface controls. A capacitive sense array is often disposed below a touch sensing surface of a touch screen, and includes an array of capacitive sense elements. Capacitances of these capacitive sense elements vary when an object (e.g., a finger, a hand, a stylus, or another object) comes into contact with or hovers above the touch sensing surface. A processing device coupled to the capacitive sense array then measures the capacitances of the capacitive sense elements and/or identifies capacitance variations of the capacitive sense elements for determining a touch or presence of the object associated with the touch sensing surface. The use of the capacitive sense array has offered a convenient and reliable user interface solution that is feasible under many harsh conditions.

Capacitive sense arrays made of capacitive sense elements have been widely used in many industrial and consumer products. However, the capacitive sense arrays oftentimes have pin limitations that make it difficult to maximize display resolutions based on requiring separate rows of pins for display and touch functionalities. For example, existing display and integrated touch circuits are limited in width to approximately 32000 micrometers. Pin pitches are typically in the region of 40 micrometers per pin, meaning a row of pins to be bonded to a panel cannot exceed approximately 800 pins in a row. It would be beneficial to integrate touch detection into existing display related infrastructure of a conventional touch screen while minimizing the number of pins required to facilitate display driving and touch sensing functions concurrently (e.g., in respective duty cycles).

### SUMMARY

Touch detection is integrated with a display screen that includes a display pixel array and a touch enabled analog front end. In some embodiments, in-cell panel technology is applied in displays, particularly in LCD and OLED panels, that incorporates touch sensors directly within display layers, eliminating a need for a separate touch layer, as in traditional on-cell or external touch layer displays. Various implementations of this application are directed to systems, devices, interfaces, and methods for configuring the same pins to enable source driving and touch sensing functionalities for integrated touch and display driver integrated circuits. These implementations overcome chip width and pin pitch limitations and allow for a greater display resolution for in-cell panel type applications without compromising touch sensing functions. In some implementations, a time-domain multiplexing scheme is used to apply a set of pins in both display driving and touch sensing functions without the need to increase the number of pins. Such multi-function use of the pins reduces the total number of pins required to implement both the display driving and touch sensing functionalities, thereby allowing more pins to be used for display driving and enhancing a display resolution associated with the in-cell panel applications. Stated in another way, in some situations, display driving and touch sensing functions are not needed simultaneously, and therefore, the time-domain multiplexing scheme can be used to alter the function of the pins to facilitate display driving and touch sensing functionalities during different temporal durations.

In accordance with one aspect of the application, an electronic system, an electronic device, a touch sensing system, or a display device is configured to operate in a display driving state and a touch sensing state. The electronic system, the electronic device, the touch sensing system, or the display device includes a plurality of display electrodes, a common electrode, a display pixel array further including a set of display pixels, and a set of source pins disposed in proximity to one or more edges of the display pixel array. Each respective display pixel of the set of display pixels is disposed between a respective one of the plurality of display electrodes and the common electrode. The common electrode is configured to provide touch sensing capabilities. Each respective source pin of the set of source pins is configured to drive a distinct column of display electrodes of the plurality of display electrodes while the electronic device is in the display driving state. A subset of the set of source pins is configured to be driven with a replica of the touch signal and electronically coupled to the common electrode while the electronic device is in the touch sensing state.

In another aspect, a method is implemented at an electronic device including (i) a plurality of display electrodes, (ii) a common electrode configured to provide touch sensing capabilities, (iii) a display pixel array further including a set of display pixels, and (iv) a set of source pins disposed in proximity to one or more edges of the display pixel array. Each respective display pixel of the set of display pixels is disposed between a respective one of the plurality of display electrodes and the common electrode. The method includes, at a first time, enabling a display driving state where each respective source pin of the set of source pins is configured to drive a distinct column of display electrodes of the plurality of display electrodes. The method further includes, at a second time, enabling a touch sensing state where a subset of the set of source pins is configured to be electrically coupled to the common electrode.

In yet another aspect of the application, a touch sensing system includes a display pixel array and a processing device. The display pixel array includes a plurality of display pixels, a plurality of display electrodes, and a plurality of common electrodes, and each display pixel is disposed between a display electrode and a common electrode. The processing device is coupled to the display pixel array and further includes a processing core, a memory coupled to the processing core, and a capacitive sensing circuit coupled to the processing core. The memory stores one or more programs configured for execution by the processing core to implement the method described herein to control a touch sensing state and a display driving state of the touch sensing system.

### BRIEF DESCRIPTION OF THE DRAWINGS

For a better understanding of the various described implementations, reference should be made to the Description of Implementations below, in conjunction with the following drawings in which like reference numerals refer to corresponding parts throughout the figures.

FIG. 1 is a block diagram illustrating an electronic system having a processing device that processes display driving signals and capacitive sense signals, in accordance with some implementations.

FIG. 2A illustrates an example touch screen assembly (e.g., a liquid crystal display screen) including a common electrode array that is reconfigured to a capacitive sense array, in accordance with some implementations.

FIG. 2B illustrates an example display pixel driven by a display electrode and a common electrode in a display driving state, in accordance with some implementations.

FIG. 3A is an example display pixel array that is reconfigured to operate as a capacitive sense array 128 in accordance with some implementations, and FIG. 3B is an example capacitive sense element that is reconfigured from a set of common electrodes of the display pixel array shown in FIG. 3A in accordance with some implementations.

FIGS. 4A to 4C illustrate an example of an electronic device that includes a display pixel array that operates at a display driving state and a touch sensing state, in accordance with some implementations.

FIG. 5 is a flowchart of a method of configuring an electronic device with a display pixel array and a set of source pins to switch between a display driving state and a touch sensing state, in accordance with some implementations.

Like reference numerals refer to corresponding parts throughout the several views of the drawings.

### DESCRIPTION OF IMPLEMENTATIONS

Reference will now be made in detail to implementations, examples of which are illustrated in the accompanying drawings. In the following detailed description, numerous specific details are set forth in order to provide a thorough understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

In accordance with various embodiments of this application, touch detection is not implemented using one or more dedicated touch sensing layers. Rather, touch detection is integrated into existing display related infrastructure (e.g., common electrodes of display pixels and related processing circuit) in a touch screen (also called in-cell display panel) causing no or little detrimental impact on display functions of a touch screen (also broadly called a display device). The touch screen includes a display pixel array that further includes a common electrode layer for providing a bias voltage or a reference voltage to each display pixel in the display pixel array. In a touch sensing state, the common electrode layer of the touch screen is configured to provide capacitive sense elements for detecting touch events on the display pixel array during a first set of time durations allocated for touch detection. In a display driving state, the same common electrode layer provides the bias or reference voltages to the display pixels of the display pixel array during a second set of time durations allocated for displaying.

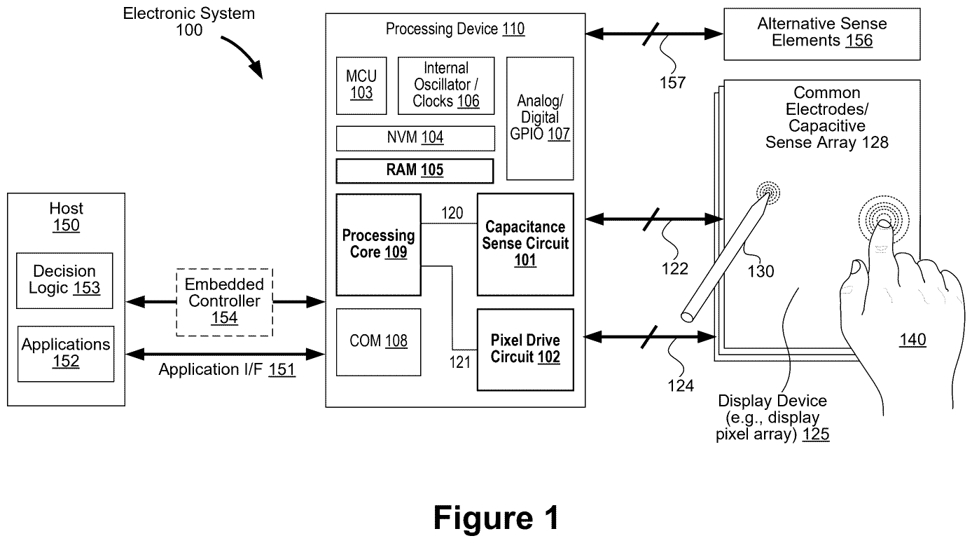

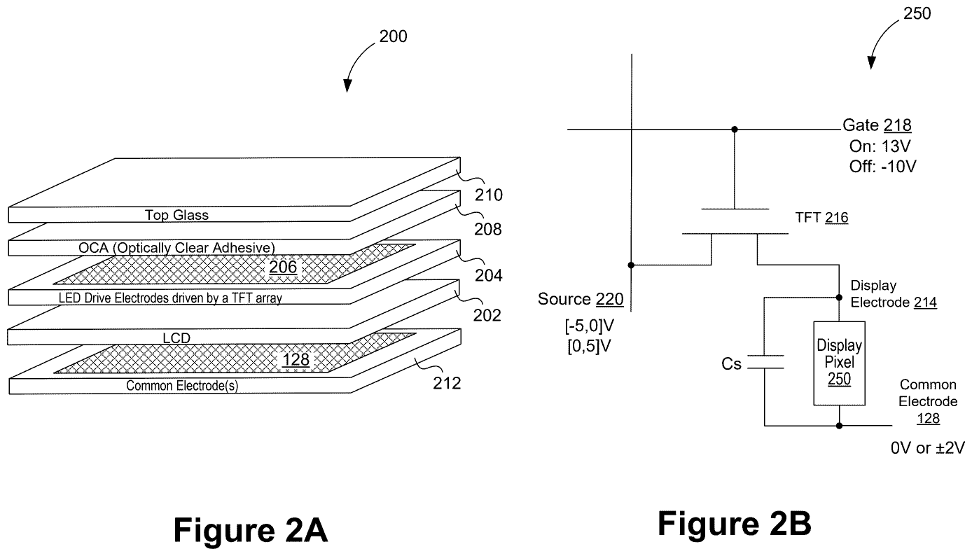

FIG. 1 is a block diagram illustrating an electronic system 100 having a processing device 110 that processes display driving signals and capacitive sense signals, in accordance with some implementations. The processing device 110 is electrically coupled to a display device 125 including a display pixel array (e.g., the display pixel array 400). The display pixel array further includes a plurality of display pixels, a plurality of display electrodes and a plurality of common electrodes 128. Each display pixel is disposed between a display electrode and a common electrode 128. More details of the display device 125 are explained below with reference to FIGS. 2A-2B, 3A-3B, and 4A-4C. The processing device 110 operates in two states including a display driving state and a touch sensing state. In the display driving state, a voltage bias is generated and applied between the display and common electrodes of each display pixel to enable display of a color on the respective display pixel. In the touch sensing state, the plurality of common electrodes 128 are reconfigured (e.g., toggled, switched) to operate as a capacitive sense array 128, and the processing device 110 is configured to measure capacitance variations at the plurality of common electrodes 128 and detect one or more touches proximate to a surface of the display device 125. In some implementations, the processing device 110 alternates between the display driving state and the touch sensing state according to a predetermined duty cycle (e.g., 80%) for the display driving state, and detects a contact with or a proximity to a touch sensing surface associated with the display pixel array without interfering with current display operations of the display pixel array.

The processing device 110 can detect conductive objects, such as touch objects 140 (e.g., a finger), a passive or active stylus 130, or any combination thereof when operating in the touch sensing state. The capacitance sense circuit 101 can measure touch data created by a touch using the capacitive sense array 128 reconfigured from the plurality of common electrodes 128. The touch may be detected by a single or multiple sensing cells, each respective sensing cell representing an isolated sense element or an intersection of sense elements (e.g., electrodes) of the reconfigured capacitive sense array 128. In some implementations, when the capacitance sense circuit 101 measures capacitance of the reconfigured capacitive sense array 128, the processing device 110 acquires a two-dimensional capacitive image of the touch sensing object and processes the capacitive image data for peaks and positional information. In some implementations, the processing device 110 is coupled to a microcontroller (e.g., an external host device 150) that obtains a capacitance touch signal data set from the reconfigured capacitive sense array 128. In some implementations, finger detection firmware executing on the microcontroller identifies data set areas that indicate touches, detects and processes peaks, calculates the coordinates, or any combination thereof. The microcontroller can report the precise coordinates and other information to an application processor.

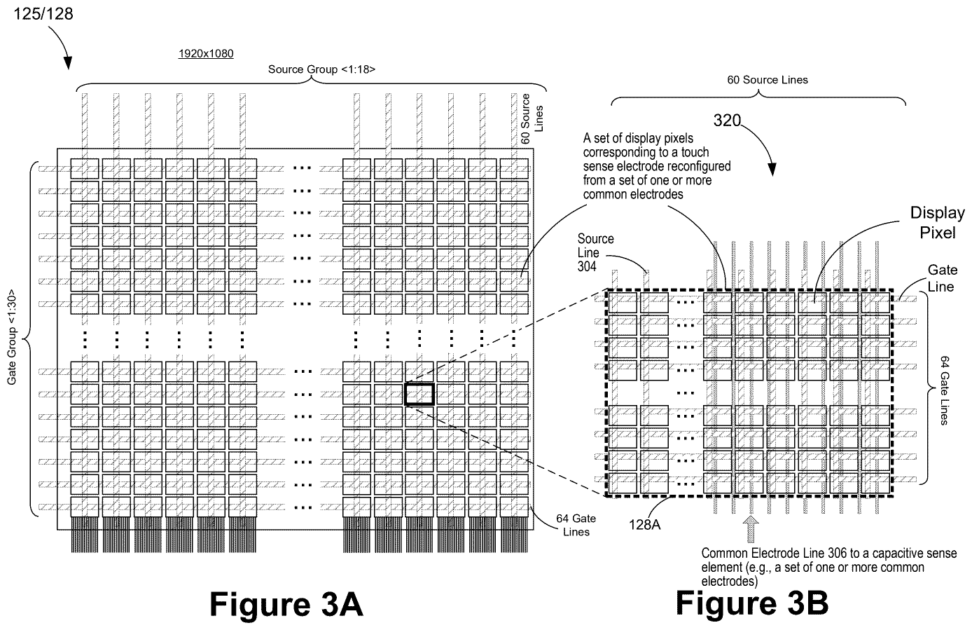

In some implementations, the electronic system 100 includes one or more of a processing device 110, a display device 125 (including a display pixel array), a stylus 130, and a host 150. The common electrodes 128 may include electrodes made of conductive material, such as copper, and are reconfigured to capacitive sense array 128 including capacitive sense elements that are electrodes made of the same conductive material. The common electrodes and sense elements may also be part of an indium-tin-oxide (ITO) panel. In the display driving state, the common electrodes 128 provide a bias voltage or a reference voltage to each display pixel of the display pixel array, thereby enabling display of a color on the respective display pixel. In the depicted embodiment, the electronic system 100 includes the common electrodes 128 coupled to the processing device 110 via a bus 124, and the common electrodes 128 are configured to receive display driving signals from the processing device 110 via the bus 124. More specifically, the display driving signals are generated by a pixel drive circuit 102 of the processing device 110. Alternatively, in the touch sensing state, the capacitive sense elements of the reconfigured capacitive sense array 128 can be used to allow the capacitance sense circuit 101 to measure self-capacitance, mutual capacitance, or any combination thereof. In the depicted embodiment, the electronic system 100 includes the reconfigured capacitive sense array 128 coupled to the processing device 110 via a bus 122, and the reconfigured capacitive sense array 128 is configured to provide capacitive sense signals to a capacitance sense circuit 101 of the processing device 110 via the bus 122. The reconfigured capacitive sense array 128 may include a multi-dimension capacitive sense array. In some implementations, the multi-dimension sense array includes multiple sense elements, organized as rows and columns. In some implementations, the reconfigured capacitive sense array 128 has a flat surface profile. In some implementations, the capacitive sense array 128 may have a non-flat surface profile. In some implementations, other configurations of capacitive sense arrays can be used. For example, instead of vertical columns and horizontal rows, the capacitive sense array 128 may have a hexagonal arrangement, or the like, as would be appreciated by one of ordinary skill in the art having the benefit of this disclosure. More details on a capacitive sense array 128 are explained below with reference to FIGS. 2A-2B and 3A-3B.

In some implementations, the electronic system 100 further includes one or more force electrodes (not shown in FIG. 1) that are disposed below the reconfigured capacitive sense array 128 and separated from the reconfigured capacitive sense array 128. The one or more force electrodes are electrically coupled to the processing device 110, and are configured to provide force signals to the processing device 110 for determining force associated with candidate touches detected from the reconfigured capacitive sense array 128. In some implementations, the force signals are measured from capacitance variation associated with the one or more force electrodes, and used to improve accuracy of touch detection based on the capacitive sensing signals.

The operations and configurations of the processing device 110 and the reconfigured capacitive sense array 128 for detecting and tracking a touch object 140 or a stylus 130 are described herein. In short, the processing device 110 is configurable to detect a presence of a touch object 140, a presence of a stylus 130 on the reconfigured capacitive sense array 128, or any combination thereof. If the touching object is an active stylus, the active stylus 130 is configured to operate as the timing “master,” and the processing device 110 adjusts the timing of the reconfigured capacitive sense array 128 to match that of the active stylus 130. In some implementations, the reconfigured capacitive sense array 128 capacitively couples with the active stylus 130, as opposed to conventional inductive stylus applications. It should also be noted that the same assembly (e.g., the processing device 110) used for the reconfigured capacitive sense array 128, which is configured to detect touch objects 140, is also used to detect and track the stylus 130 without an additional PCB layer for inductively tracking the active stylus 130.

In some implementations, the processing device 110 includes analog and/or digital general purpose input/output (“GPIO”) ports 107. GPIO ports 107 may be programmable. GPIO ports 107 may be coupled to a Programmable Interconnect and Logic (“PIL”), which acts as an interconnect between GPIO ports 107 and a digital block array of the processing device 110 (not shown). In some implementations, the digital block array is configured to implement a variety of digital logic circuits (e.g., DACs, digital filters, or digital control systems) using configurable user modules (“UMs”). The digital block array may be coupled to a system bus. The processing device 110 may also include memory, such as random access memory (“RAM”) 105 and non-volatile memory (“NVM”) 104. RAM 105 may be static RAM (“SRAM”). The non-volatile memory 104 may be a flash memory, which may be used to store firmware (e.g., control algorithms executable by processing core 109 to implement operations described herein). The processing device 110 may also include a memory controller unit (“MCU”) 103 coupled to memory and the processing core 109. The processing core 109 is a processing element configured to execute instructions or perform operations. The processing device 110 may include other processing elements as would be appreciated by one of ordinary skill in the art having the benefit of this disclosure. It should also be noted that the memory may be internal to the processing device 110 or external to it. In the case of the memory being internal, the memory may be coupled to a processing element, such as the processing core 109. In the case of the memory being external to the processing device 110, the processing device 110 is coupled to the other device in which the memory resides as would be appreciated by one of ordinary skill in the art having the benefit of this disclosure.

Some or all of the operations of the processing core 109 may be implemented in firmware, hardware, software, or some combination thereof. The processing core 109 may receive signals from the capacitance sense circuit 101, determine the state of the reconfigured capacitive sense array 128 (e.g., determining whether an object is detected on or in proximity to the touch sensing surface), resolve where the object is on the sense array (e.g., determining the location of the object), track the motion of the object, or generate other information related to an object detected at the touch sensor. In some implementations, the processing core 109 includes the capacitance sense circuit 101. In some implementations, the processing core 109 performs some or all the functions of capacitance sense circuit 101. Additionally, in some implementations, the processing core 109 provides display information to the pixel drive circuit 102, such that the pixel drive circuit 102 can be configured to drive individual display pixels in the display device 125 to display images or videos based on the display information. In some implementations, the processing core 109 includes some or all functions of the pixel drive circuit 102, i.e., part or all of the pixel drive circuit 102 is integrated in the processing core 109.

In some implementations, the processing core 109 generates a touch detection enable signal 120 and a display driving enable signal 121 that are synchronized to control the capacitance sensing circuit 101 and the pixel drive circuit 102 to detect touch locations and drive individual display pixels, respectively. The touch detection enable signal 120 is used to enable a touch sensing state. In the touch sensing state, the common electrodes 128 are decoupled from the pixel drive circuit 102 and reconfigured to the capacitive sense array 128 coupled to the capacitance sense circuit 101. Self or mutual capacitance of sense elements of the reconfigured capacitive sense array 128 is scanned by the capacitance sense circuit 101. One or more touch locations are thereby detected if one or more objects touch the touch sensing surface of the electronic system 100. Alternatively, in some implementations, the display driving enable signal 121 is used to enable a display driving state (e.g., decouple the capacitance sense circuit 101 from the reconfigured capacitive sense array 128 and couple the pixel drive circuit 102 to the common electrodes 128). In such a display driving state, the pixel drive circuit 102 enables a bias voltage and a reference voltage corresponding to an intended color on each display pixel of the display pixel array. The display pixel displays the intended color when the bias voltage and the reference voltage are applied on the display and common electrodes of the respective display pixel. It is noted that the touch detection enable signal 120 and the display driving enable signal 121 can be enabled sequentially and share operation time of the common electrodes/capacitive sense array 128.

The processing device 110 may also include an analog block array (not shown) (e.g., field-programmable analog array). The analog block array is also coupled to the system bus. An analog block array may be configured to implement a variety of analog circuits (e.g., ADCs or analog filters) using, in some implementations, configurable UMs. The analog block array may also be coupled to the GPIO 107.

In some implementations, the capacitance sense circuit 101 is integrated into the processing device 110. The capacitance sense circuit 101 includes analog I/O for coupling to an external component, such as a touch-sensor pad (not shown), a reconfigured capacitive sense array 128, a touch-sensor slider (not shown), a touch-sensor buttons (not shown), and/or other devices. The capacitance sense circuit 101 may be configured to measure capacitance using mutual-capacitance sensing techniques, self-capacitance sensing technique, charge-coupling techniques, charge balancing techniques, or the like. In some implementations, the capacitance sense circuit 101 operates using a charge accumulation circuit, a capacitance modulation circuit, or other capacitance sensing methods known by those skilled in the art. In some implementations, other capacitance sensing circuits may be used. The mutual capacitive sense arrays, or touch screens, as described herein, may include a transparent, conductive sense array disposed on, in, or under either a visual display itself (e.g. LCD monitor), or a transparent substrate in front of the display.

A reconfigured capacitive sense array 128 includes a plurality of sense elements. When a touch object, such as a finger 140 or stylus 130, approaches the reconfigured capacitive sense array 128, the object causes a decrease in mutual capacitance between some of the sense elements. In some implementations, the presence of a finger increases the capacitance of the electrodes to the environment (Earth) ground, typically referred to as self-capacitance change. In some implementations, the plurality of sense elements of the reconfigured capacitive sense array 128 are configured to operate as transmit (TX) electrodes and receive (RX) electrodes of a mutual capacitive sense array in a first mode to detect touch objects, and to operate as electrodes of a coupled-charge receiver in a second mode to detect a stylus on the same electrodes of the sense array. Specifically, in the first mode, a mutual capacitance is measured at an intersection of a RX electrode and a TX electrode when a transmit signal provided at the RX electrode is coupled to the TX electrode. Utilizing the change in mutual capacitance, the location of the finger on the reconfigured capacitive sense array 128 is determined by identifying an RX electrode having a decreased coupling capacitance with a TX electrode whose signal was applied at the time the decreased capacitance is measured on the RX electrode. Therefore, the locations of one or more touch objects can be determined by sequentially scanning the capacitances associated with the intersection of electrodes. In some implementations, in the second mode, the stylus 130 is activated to generate a stylus transmit signal, which is then coupled to a subset of sense elements of the reconfigured capacitive sense array 128 that is located below the stylus 130.

In some implementations, the processing device 110 calibrates the sense elements (intersections of RX and TX electrodes) by determining baselines for the sense elements. In some implementations, interpolation is used to detect finger position at better resolutions than a spatial pitch of the sense elements of the reconfigured capacitive sense array 128, and various types of coordinate interpolation algorithms are optionally used to detect a center location of a touch.

The processing device 110 may include internal oscillator/clocks 106 and a communication block (“COM”) 108. In some implementations, the processing device 110 includes a spread-spectrum clock (not shown). The oscillator/clocks 106 provides clock signals to one or more of the components of processing device 110. The communication block 108 may be used to communicate with an external component, such as an application processor 150, via an application interface (“I/F”) line 151. In some implementations, the processing device 110 may also be coupled to an embedded controller 154 to communicate with the external components, such as a host 150. In some implementations, the processing device 110 is configured to communicate with the embedded controller 154 or the host 150 to send and/or receive data.

The processing device 110 may reside on a common carrier substrate such as, for example, an integrated circuit (“IC”) die substrate, a multi-chip module substrate, or the like. In some implementations, the components of the processing device 110 may be one or more separate integrated circuits and/or discrete components. In some implementations, the processing device 110 may be one or more other processing devices known by those of ordinary skill in the art, such as a microprocessor or central processing unit, a controller, a special-purpose processor, a digital signal processor (“DSP”), an application specific integrated circuit (“ASIC”), a field programmable gate array (“FPGA”), or the like.

It is also noted that the implementations described herein are not limited to having a configuration of a processing device coupled to an application processor, but may include a system that measures the capacitance on the capacitive sense array and sends the raw data to a host computer 150 where it is analyzed by an application. In effect, the processing that is done by the processing device 110 may also be done in the application processor. Specifically, in some implementations, instead of performing the operations of the processing core 109 in the processing device 110, the processing device 110 may send the raw data or partially-processed data to the host 150. The host 150, as illustrated in FIG. 1, may include decision logic 153 that performs some or all of the operations of the processing core 109. Operations of the decision logic 153 may be implemented in firmware, hardware, software, or a combination thereof. The host 150 may include a high-level Application Programming Interface (API) in applications 152 that perform routines on the received data, such as compensating for sensitivity differences, other compensation algorithms, baseline update routines, start-up and/or initialization routines, interpolation operations, or scaling operations. The operations described with respect to the processing core 109 may be implemented in the decision logic 153, the applications 152, or in other hardware, software, and/or firmware external to the processing device 110. In some other embodiments, the processing device 110 is the host 150.

The capacitance sense circuit 101 may be integrated into the IC of the processing device 110, or in a separate IC. In some implementations, descriptions of capacitance sense circuit 101 may be generated and compiled for incorporation into other integrated circuits. For example, behavioral level code describing the capacitance sense circuit 101, or portions thereof, may be generated using a hardware descriptive language, such as VHDL or Verilog, and stored to a machine-accessible medium (e.g., CD-ROM, hard disk, floppy disk, or flash memory). Furthermore, the behavioral level code can be compiled into register transfer level (“RTL”) code, a netlist, or a circuit layout and stored to a machine-accessible medium. The behavioral level code, the RTL code, the netlist, and the circuit layout may represent various levels of abstraction to describe the capacitance sense circuit 101.

It is noted that the components of the electronic system 100 may include all the components described above. In some implementations, the electronic system 100 includes fewer than all of the components described above.

In some implementations, the electronic system 100 is used in a tablet computer. In some implementations, the electronic device is used in other applications, such as a notebook computer, a mobile handset, a personal data assistant (“PDA”), a keyboard, a television, a remote control, a monitor, a handheld multi-media device, a handheld media (audio and/or video) player, a handheld gaming device, a signature input device for point of sale transactions, an eBook reader, a global position system (“GPS”), or a control panel. The embodiments described herein are not limited to touch screens or touch-sensor pads for notebook implementations. Implementations can be used in other capacitive sensing devices, such as a touch-sensor slider (not shown) or touch-sensor buttons (e.g., capacitance sensing buttons). In some implementations, these sensing devices include one or more capacitive sensors or other types of capacitance-sensing circuitry. The operations described herein are not limited to notebook pointer operations, but can include other operations, such as lighting control (dimmer), volume control, graphic equalizer control, speed control, or other control operations requiring gradual or discrete adjustments. It should also be noted that these capacitive sensing implementations may be used in conjunction with non-capacitive sensing elements, including but not limited to pick buttons, sliders (e.g., display brightness and contrast), scroll-wheels, multi-media control (e.g., volume, track advance), handwriting recognition, and numeric keypad operation.

In some implementations, the electronic system 100 further includes one or more alternative sense elements 156 configured to communicate with the processing device 110 via a bus 157. Each alternative sense element 156 is optionally a capacitance based sensor or a non-capacitance sensor. Example alternative sense elements 156 include, but are not limited to, an ambient light sensor, a capacitive touch button, and a side touch sensor.

FIG. 2A illustrates an example touch screen assembly 200 (e.g., a liquid crystal display screen) including a common electrode array that is reconfigured to a capacitive sense array 128, in accordance with some implementations. The touch screen assembly 200 includes a liquid crystal display (LCD) 202 overlaid by the glass 204. A display pattern 206 is constructed on a surface of the glass 204 to form a footprint of a display pixel array. Optionally, as shown in FIG. 2A, the display pattern 206 is constructed on a top surface of the glass 204 that faces away from the LCD 202 or on a bottom surface of the glass 204 that faces the LCD 202. The display pattern 206 includes a plurality of display electrodes for driving a plurality of display pixels made of LCD molecules of the LCD 202. Optically clear adhesive (OCA) 208 is used to bond a top glass 210 to the surface of the glass 204 on which the display pattern 206 is constructed, thus protecting the display pattern 206. The touch screen assembly 200 further includes a common electrode array 128 opposing the plurality of display electrodes formed on display pattern 206. Stated another way, the common electrode array 128 is formed on a glass 212 disposed under the LCD 202 and oppose the glass 204. As such, each display pixel of the LCD 202 is disposed between a respective display electrode and a respective common electrode that are formed on the display pattern 206 and the common electrode layer 128, respectively.

In some implementations not shown in FIG. 2A, the display pattern 206 is constructed on a surface of the glass 204 to form a footprint of a display pixel array, and the glass 204 is disposed under the LCD 202. The common electrode array 128 is formed on the glass 212, and the glass 212 is disposed above the LCD 202 and oppose the glass 204. The top glass 210 is bonded to the glass 212 using OCA 208 for protecting the common electrode layer 128. Each display pixel of the LCD 202 is still disposed between a respective display electrode and a respective common electrode that are formed on the display pattern 206 and the common electrode layer 128, respectively.

In some implementations, a first thin film transistor (TFT) array is formed on the glass 204 to drive the display electrodes formed on the display pattern 206. More specifically, a gate layer, a semiconductor layer, a source/drain layer, one or more conductive layers and one or more intervening insulating layers are deposited on the glass 204. These material layers are lithographically patterned on the glass 204 to form functional part (e.g., gate, source and drain) of the TFTs as well as the row and column lines of the first TFT array. For each individual display pixel of the LCD 202, the respective display electrode is electrically coupled to a respective TFT of the first TFT array. The first TFT array is configured to receive display driving signals from the processing device 110 (more specifically, the pixel drive circuit 102 of the processing device 110), and generates a first electrical voltage or current to drive the display electrode of each display pixel. As the first electrical voltage or current is applied to the liquid crystal molecules corresponding to each display pixel, the molecules tend to untwist from its original twisted form, and cause a change in the angle of an incident light. Stated another way, the first TFT array includes a two dimensional (2D) array of TFTs, row lines and column lines. As shown in FIG. 2B, each TFT of the first TFT array is connected between a respective row line and a respective column line, and configured to provide the first electrical voltage or current to drive the corresponding liquid crystal molecules of the corresponding display pixel. In some implementations, the entire common electrode layer 128 is electrically coupled to a reference voltage (sometimes referred to as VCOM). In some implementations, the common electrodes 128 corresponding to the display pixels are driven individually or in group as explained below.

It is noted that in some implementations, a second thin film transistor (TFT) array is formed on the glass 212 to drive the common electrodes 128. More specifically, a gate layer, a semiconductor layer, a source/drain layer, one or more conductive layers and one or more intervening insulating layers are deposited on the glass 212. These material layers are lithographically patterned on the glass 212 to form functional part (e.g., gate, source and drain) of the second TFTs as well as the row and column lines of the second TFT array. For each individual display pixel of the LCD 202, the respective common electrode is electrically coupled to a respective TFT of the second TFT array. The TFT array is configured to receive display driving signals from the processing device 110, and generates a second electrical voltage or current to drive the common electrode corresponding to each display pixel. As the first and second electrical voltages/currents are applied to the liquid crystal molecules corresponding to each display pixel, the molecules tend to untwist from its original twisted form, and cause a change in the angle of an incident light. Stated another way, the second TFT array includes a two dimensional (2D) array of TFTs, row lines and column lines. Each TFT of the second TFT array is connected between a respective row line and a respective column line, and configured to provide the second electrical voltage or current to drive the corresponding liquid crystal molecules of the corresponding display pixel in conjunction with the first electrical voltage or current. In some implementations, the common electrodes 128, the display electrodes, the first TFT array and the second TFT array (if used) are made of transparent material (e.g., indium-tin oxide (ITO)) to allow light to pass through from the side or the back of the touch screen assembly 200.

Optionally, the common electrode array 128 has a diamond pattern, a row-column pattern or a two-dimensional (2D) array of common electrodes (as shown in FIG. 3A). In some implementations related to the row-column pattern, the capacitive sense array 128 reconfigured from the common electrode array 128 includes row and column sense elements that can be expressed as a matrix of the intersections between row and column electrodes. In some implementations, the row and column sense elements are formed on two conductive layers that are electrically insulated from each other, and both of the conductive layers are formed on one of the top or bottom surfaces of the glass 212. In some implementations related to the 2D array of common electrodes, the 2D array of common electrodes includes a plurality of square or rectangular electrodes, and when reconfigured to the capacitive sense array 128, a set of adjacent common electrodes (e.g., a 2D array of 64×60 common electrodes) is grouped into a unit sense element for touch detection. The resolution of the common electrodes 128 is represented as the product of the number of rows and the number of columns associated with the common electrodes 128. The resolution of the reconfigured capacitive sense array 128 is represented as the product of the number of rows and the number of columns associated with the capacitive sense elements. The resolutions of the common electrodes 128 and the reconfigured capacitive sense array 128 could be identical or distinct.

FIG. 2B illustrates an example display pixel 250 driven by a display electrode 214 and a common electrode 128 in a display driving state, in accordance with some implementations. As explained above, the display pixel 250 is disposed between the display and common electrodes. A first TFT 216 is connected between a respective row line coupled to a gate 218 218 and a respective column line coupled to a source 220, and configured to provide the first electrical signal to drive the display electrode 214 of the corresponding display pixel 250. In the case of LCD display pixels, the first electrical signal and another second electrical signal are applied onto the display and common electrodes, respectively, and therefore to the liquid crystal molecules corresponding to the display pixel 250. The molecules tend to untwist from their original twisted form, and cause a change in the angle of an incident light, thereby causing display of a color at a location corresponding to the display pixel 250.

The first TFT 216 is formed on the glass 204 to drive the display electrode 214 that is formed on the same glass substrate. More specifically, a gate layer, a semiconductor layer, a source/drain layer, one or more conductive layers and one or more intervening insulating layers are deposited on the glass 204. These material layers are lithographically patterned on the glass 204 to form functional part (e.g., gate, source and drain) of the first TFT 216 as well as the row (gate) line 218 and the column (source) line 220 of the first TFT 216. The first TFT 216 is configured to receive display driving signals from the processing device 110 (more specifically, the pixel drive circuit 102 of the processing device 110), and generates the first electrical signal to drive the display electrode 214 of the display pixel 250.

In some implementations (not shown in FIG. 2B), the display pixel 250 includes a second TFT to generate the second electrical signal to drive the common electrode 128. The second TFT is formed on the glass to drive the common electrode 128 that is formed on the same glass substrate. A gate layer, a semiconductor layer, a source/drain layer, one or more conductive layers and one or more intervening insulating layers are deposited on the glass 212. These material layers are lithographically patterned on the glass 204 to form functional part (e.g., gate, source and drain) of the second TFT as well as a row (gate) line and a column (source) line of the second TFT. The first TFT is configured to receive the display driving signals from the processing device 110 (more specifically, the pixel drive circuit 102 of the processing device 110), and generates the second electrical signal to drive the common electrode 128 of the display pixel 250.

In an example, in the display driving state, the common electrode 128 is coupled to the ground (e.g., 0V) or another reference voltage (e.g., 2V and −2 V). The gate line 218 is coupled to a TFT turn-on voltage V_{GH} (e.g., 13V) to turn on the first TFT 216, such that the display electrode 214 is electrically driven by an electrical signal delivered to the source 220 of the first TFT 216. Optionally, the electrical signal of the source 220 has a magnitude of +5V or −5V, and the first electrical signal applied on the display electrode 214 tracks the electrical signal of the source. In another example, the common electrode 128 is coupled to the ground (e.g., 0V). The gate line 218 is coupled to a TFT turn-off voltage V_{GL} (e.g., −10V) to turn off the first TFT 216, such that the display electrode 214 is electrically decoupled from the electrical signal delivered to the source 220 of the TFT 216. Regardless of the magnitude of the electrical signal the source 220 has, the first electrical signal at the display electrode 214 does not track the electrical signal of the source 220.

FIG. 3A is an example display pixel array 125 that is reconfigured to a capacitive sense array 128 in accordance with some implementations, and FIG. 3B is an example capacitive sense element 320 that is reconfigured from a set of one or more common electrodes 128 of the display pixel array 125 shown in FIG. 3A, in accordance with some implementations. The display pixel array has a first resolution (e.g., 1920×1080), and the capacitive sense array 128 reconfigured from the display pixel array has a second resolution (e.g., 30×18). The display pixel array includes a plurality of display pixels (e.g., approximately 2M pixels arranged on the LCD 202), a plurality of display electrodes (e.g., approximately 2M display electrodes arranged on the glass 204), and a plurality of common electrodes. Each display pixel 250 is disposed between a display electrode 214 and a common electrode 128. Each display pixel 250 is accessed by a column line (also called a source line 220) and a row line (also called a gate line 218). The column and row lines are configured to control the respective TFT 216 associated with each display pixel 250 to drive the display electrode 214. In an example, the display pixel array has a first number (e.g., approximately 2M) of display pixels 250 arranged to 1920 rows and 1080 columns.

In some implementations, the common electrodes 128 of the display pixel array are reconfigured to operate as the capacitive sense array 128 having the second resolution, such that the capacitive sense array 128 includes a second number (e.g., 540) of capacitive sense elements. In a specific example as shown in FIG. 3B, each capacitive sense element corresponds to 64 rows and 60 columns of display pixels, and therefore, the entire capacitive sense array 128 has the second resolution of 30×18. Stated another way, the display pixel array includes an array of 1920×1080 display pixels and is divided into 30×18 pixel sets, and each pixel set includes 64×60 display pixels. One or more common electrodes 128 correspond to each pixel set and a respective capacitive sense element of the capacitive sense array 128. The pixel set corresponding to each sense element of the capacitive sense array 128 is driven by 64 gate lines and 60 source lines. In some implementations, the pixel set corresponding to each sense element of the capacitive sense array 128 includes a single common electrode 128, i.e., 64×60 display pixels 250 share the single common electrode 128. In some implementations, the pixel set corresponding to each sense element of the capacitive sense array 128 includes a third number (e.g., 64×60 or less) of common electrodes. Optionally, each of the third number of common electrodes corresponds to one or more display pixels 250 in the pixel set. Optionally, the third number of common electrodes are electrically coupled to each other to provide the corresponding sense element of the capacitive sense array 128.

Referring to FIG. 3A, in a touch sensing state, the second number of sense elements of the reconfigured capacitive sense array 128 are scanned for detecting a contact with or a proximity to a touch sensing surface associated with the display pixel array. Further, referring to FIG. 3B, each sense element of the reconfigured capacitive sense array 128 include a set of one or more common electrodes 128 that are grouped to provide one or more touch sense signals. The touch sense signals of each sense element are measured by the capacitive sense circuit 101 of the processing device 110 for touch detection in the touch sensing state. The set of common electrodes 128 in each capacitive sense element are capacitively coupled to an associated set of display electrodes 214 via the set of display pixels 250, and to the gate lines 218 and the source lines 220 via the TFTs 216 of the set of display pixels 250. Further, in some embodiments, the common electrodes 128 in each sense element 320 are also capacitively coupled to touch sense signals of other sense elements when the touch sense signals are routed via the respective sense element to an edge of the display device 125 to gain access to the processing device 110. In some embodiments, when the common electrodes 128 of the display pixel array are reconfigured to operate as the capacitive sense array 128, parasitic capacitance is created for each sense element of the capacitive sense array 128 because of existence of the corresponding display electrode 214, gate lines, source lines 304, and lines 306 connected to common electrodes of other sense elements.

Referring to FIG. 3B, in some embodiments, the capacitive sense element 320 corresponds to a set of one or more common electrodes 128 that has a footprint substantially overlapping the set of display pixels. In an example, the capacitive sense element 320 includes a single common electrode 128A. In another example, the capacitive sense element 320 includes more than one common electrode 128A that is electrically coupled to each other. For each capacitive sense element 320, a respective common electrode line 306 is routed on the capacitive sense array 128 and electrically coupled to the respective common electrode(s) 128A of the capacitive sense element 320.

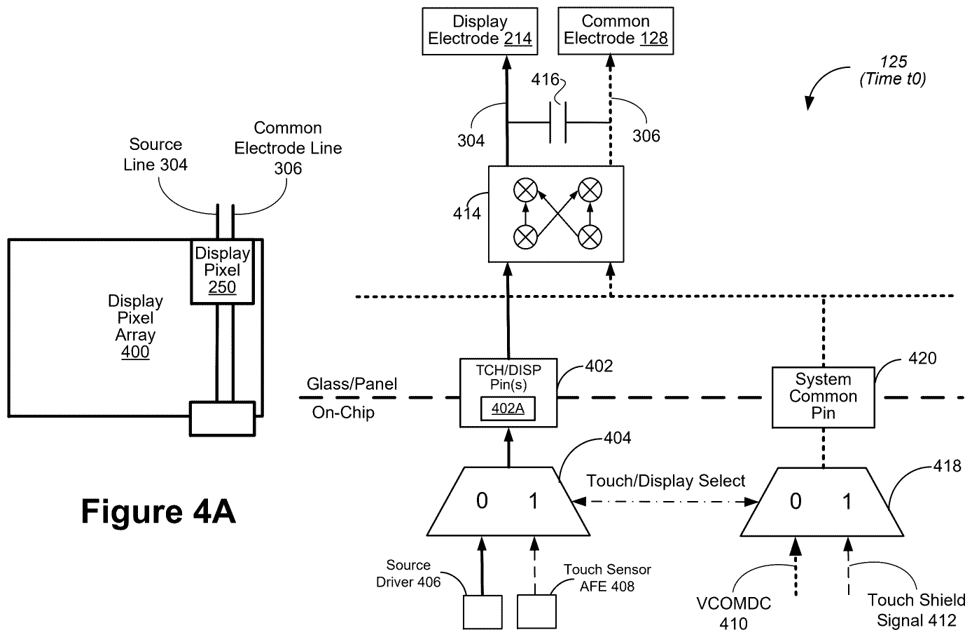

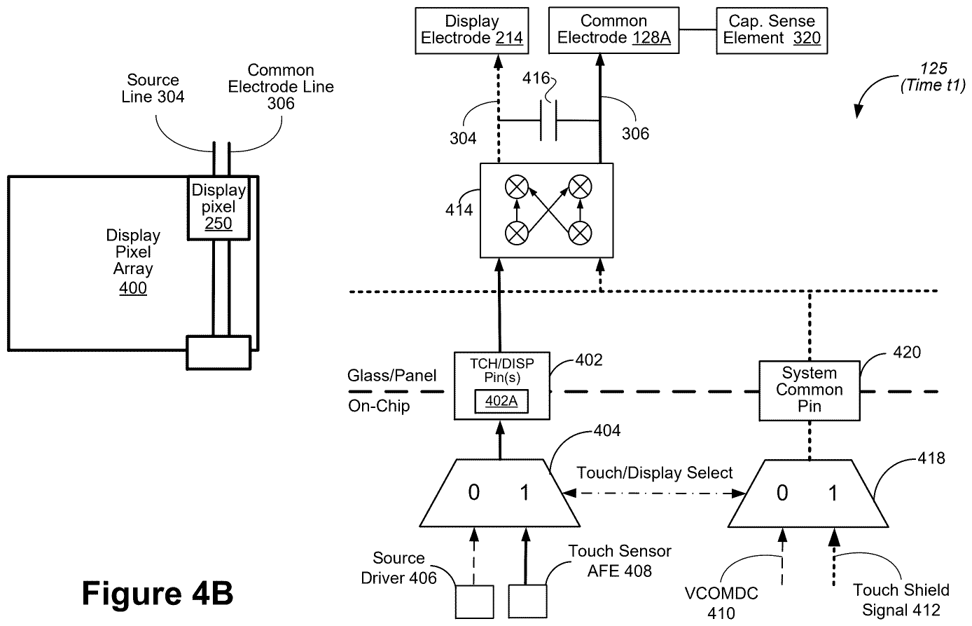

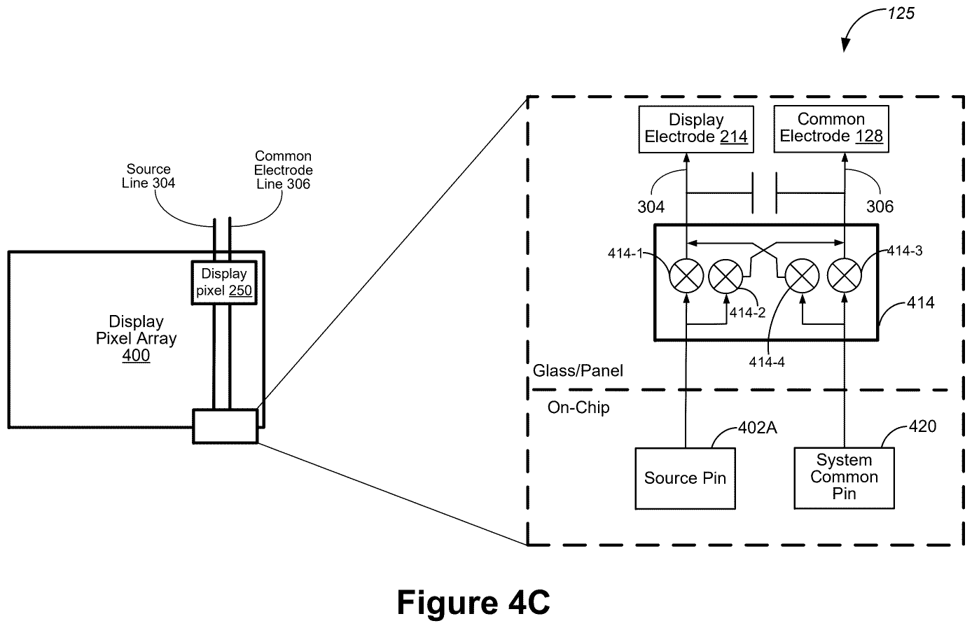

FIGS. 4A and 4B illustrate an example of a display device 125 including a display pixel array 400 that operates at a display driving state (FIG. 4A) and a touch sensing state (FIG. 4B), in accordance with some implementations. The display pixel array 400 is included in the display device 125 (e.g., a touch display), and alternates between the display driving state and the touch sensing state in a time-multiplexed manner. For example, the display pixel array 400 operates at the display driving state during a first duty cycle including a first time t0 in FIG. 4A and at the touch sensing state during a second distinct duty cycle including a second time t1 in FIG. 4B. The second duty cycle is distinct from (e.g., does not overlap and is entirely excluded from) the first duty cycle. In other words, as illustrated by FIGS. 4A and 4B, the display pixel array 400 is configured to alternate between the display driving state (FIG. 4A) and the touch sensing state (FIG. 4B) according to a predetermined duty cycle for the display driving state, thereby detecting a touch event (e.g., a physical contact with a touch sensing surface, a hover that is in proximity to a touch sensing surface. The touch event is detected by a touch sensor that is reconfigured from the common electrode 128 of the display pixel array 400 without interfering with display operations of the display pixel array 400.

The display device 125 includes a set of source pins 402 disposed in proximity to one or more edges of the display pixel array 400. Each source pin 402 may be coupled to a source line 304, and configured to drive a distinct column of display electrodes 214 of the plurality of display electrodes of the display pixel array 400 while the display device 125 is in display driving state. A subset of the set of source pins 402 is configured to be electrically coupled to a common electrode 128A (e.g., of a capacitive sense element in FIG. 3B) via an respective common electrode line 306 while the display device 125 is in a touch sensing state. In some implementations the common electrode 128A is between 3 to 5 millimeters squared and corresponds to 30-50 source pins. In an example, each respective source pin 402 of the display pixel array 400 has a pitch of 30-50 micrometers. As shown in FIGS. 4A to 4C, a source driver 406 and a touch sensor AFE 408 are coupled to the source pin 402 via a first multiplexer 404. In the display driving state (FIG. 4A), the source driver 406 is selected to be coupled to the source line 304, and configured to drive the display electrodes 214 coupled to the source line 304. In the touch sensing state (FIG. 4B), the touch sensor AFE 408 is selected to be coupled to the common electrode line 306, and configured to receive a capacitive sense signal and determine whether a touch event occurs to the corresponding capacitive sense element 320 based on the capacitive sense signal.

In accordance with some embodiments, the display device 125 shown in FIG. 4A includes a switch component 414 including a set of one or more electronic switches. The switch component 414 (e.g., a first switch) is configured to enable a first source line 304 corresponding to a first column of display electrodes (not common electrode 128) to be electrically coupled to a first source pin 402A (e.g., driven by a source driver 406) while the display device 125 is in the display driving state (FIG. 4A). The switch component 414 (e.g., a second switch) is configured to enable the common electrode 128A to be electrically coupled to the first source pin 402A in the touch sensing state (FIG. 4B). The common electrode 128 applied in the display driving state is re-configured and used as the common electrode 128A in the touch sensing state. When the first switch and the second switch are both applied, the second switch may be the same switch as, or distinct from, the first switch. Each of the first and second switches may include a combination of two or more switches or a multiplexer. In some embodiments, each of the first switch and the second switch includes a thin film transistor (TFT) device.

For clarification, in some embodiments, the switch component 414 is configured to (1) in the display driving state (FIG. 4A), enable a first source line 304 corresponding to a first column of display electrodes to be electrically coupled to a first source pin 402A and enable the common electrode 128 to be electrically coupled to the system common pin 420 and (2) in the touch sensing state (FIG. 4B), enable the common electrode 128A to be electrically coupled to the first source pin 402A and enable the first source line 304 to be electrically coupled to the system common pin 420.

In some embodiments, the display device 125 further includes a system common pin 420, e.g., disposed on an edge or inside the active area of a display panel. The system common pin 420 is configured to be electrically coupled to the common electrode 128 via a low impedance common net in the display drive state (FIG. 4A), and to the plurality of display electrodes 214 at the touch sensing state (FIG. 4B). Further, in some embodiments, referring to FIGS. 4A and 4B, the set of one or more electrical switches of the switch component 414 are configured to enable the common electrode line 306 of the common electrode 128 of the display pixels 250 to be electrically coupled to the system common pin 420 in the display drive state and enable the source line 304 to be electrically coupled to the system common pin 420 in the touch sensing state. Referring to FIGS. 4A and 4B, a common electrode signal 410 (also called VCOMDC signal 410) and a touch shield signal 412 are coupled to the system common pin via a second multiplexer 418. In the display driving state (FIG. 4A), the VCOMDC signal 410 is selected to be coupled to the common electrode line 306 and the common electrode 128 of the display pixels 250, and configured to hold the common electrode 128 of the display pixels 250 at a display reference voltage (e.g., ground). In the touch sensing state (FIG. 4B), the touch shield signal 412 is selected to be coupled to the source line 304, and configured to apply a source line shielding voltage reducing an impact of parasitic capacitance associated with the display pixel array 125.

In some implementations, the plurality of display electrodes (corresponding to display pixel 250) and the common electrode 128 are disposed on an ITO panel that includes multiple layers (e.g., at least three vertical layers), and a respective vertical layer of the multiple layers includes the TFT switches that are configured to couple to the set of source pins 402. In some implementations, for each respective display pixel 250, the respective display electrode 214 and the common electrode 128A form a respective pixel capacitor 416 that is charged in the display drive state, when the respective display electrode 214 is driven by a source drive voltage provided via a respective source pin 402 and the common electrode 128A is driven by a pixel reference voltage provided via a system common pin 420.

In some situations, during time durations allocated for touch detection, a set of common electrodes is driven with an integration voltage, and one or more electrical nodes are driven in a synchronous manner with the set of common electrodes. Both the set of common electrodes and the one or more electrical nodes are driven at the same slew rate and have the same voltage variation, thereby reducing the impact of parasitic capacitance between the one or more electrical nodes and the set of common electrodes on touch detection implemented via the common electrodes. As such, touch detection based on the common electrodes used for display driving does not cause any detrimental impact on display functions of the touch screen, and complements/replaces conventional touch detection methods that are required to use additional and dedicated touch sensing layers.

Referring to FIGS. 4A and 4B, in some embodiments, the display device 125 includes a panel on which the display pixels 250 are formed and a processing device 110 formed on a different substrate of the panel. The processing device 110 further includes the source driver 406, the touch sensor AFE 408, circuit generating the VCOMDC signal 410 and touch shield signal 412, and the multiplexers 404 and 418. The processing device 110 is physically and electrically coupled to the panel to form the display device 125, e.g., flip chip bonding or wire bonding. Each of the panel and the processing device 110 includes a set of source pins 402 and a system common pin 420. The set of source pins 402 and the system common pin 420 of the panel may be aligned with the set of source pins 402 and the system common pins 420 of the processing device 110.

In some implementations, the predetermined duty cycle for the display driving state (illustrated by FIG. 4A) is a first duty cycle, and the touch sensing state (illustrated by FIG. 4B) is a second duty cycle, different than the first duty cycle. In some implementations the display pixel array 400 is configured to have a higher refresh rate during the first duty cycle (e.g., 200 to 300 Hz), than a lower refresh rate during the second duty cycle (e.g., 40 to 80 Hz). In other words, the display driving state corresponds to a higher refresh rate than that of the touch sensing state. In some implementations, the set of source pins 402 is configured to provide a shield signal (e.g., touch shield signal 412) while the display device 125 is in the touch sensing state. Conversely, in some implementations, the display pixel array 400 is configured to have a lower refresh rate during the first duty cycle than a lower refresh rate during the second duty cycle.

FIG. 4C shows another example embodiment of a display device 125 that separates source pins 402 providing display driving signals and a system common pin 420 for detecting capacitive sense signals, in accordance with some embodiments contemplated herein. The source pins 402 and the system common pin 420 may be selectively coupled to the source line 304 during the display driving state and touch sensing state, respectively.

In some embodiments, a switch component 414 (e.g., a first switch 414-1) is configured to enable a first source line 304 coupled to a display electrode 214 to be electrically coupled to a first source pin 402A while the display device 125 is in the display driving state (FIG. 4A), and disable the first source line 304 from being electrically coupled to the first source pin 402A in the touch sensing state (FIG. 4B). The switch component 414 (e.g., a second switch 414-2) is configured to enable the common electrode 128 (e.g., reconfigured to common electrode 128A) to be electrically coupled to the first source pin 402A in the touch sensing state (FIG. 4B). Further, in some embodiments, a third switch 414-3 is configured enable the system common pin 420 to be electrically coupled to a common electrode line 306 in the display drive state (FIG. 4A), and a fourth switch 414-4 is configured to enable the system common pin 420 to be electrically coupled to a display electrode line 304 in the touch sensing state (FIG. 4B). When a switch is enabled or turned on, a low resistance electrical path (e.g., having a resistance lower than a first resistance threshold) is formed, and conversely, when a switch is disabled or turned off, a high resistance electrical path (e.g., having a resistance greater than a second resistance threshold) is formed.

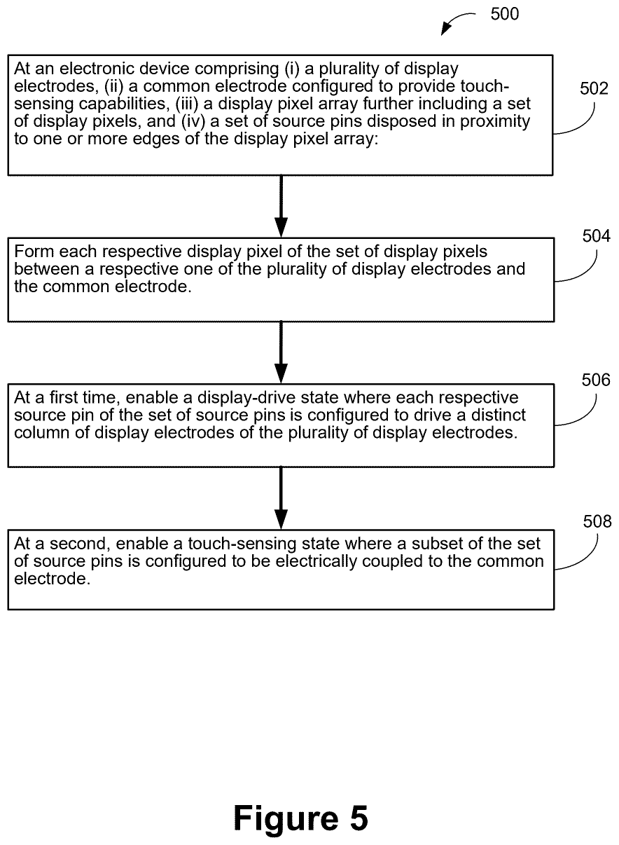

FIG. 5 is a flowchart of a method 500 of configuring a display device 125 with a display pixel array and a set of source pins 402 to switch between a display driving state and a touch sensing state, in accordance with some implementations. The method 500 is implemented (operation 502) at a display device 125 that includes a plurality of display electrodes 250, a common electrode 128, a display pixel array 400, and a set of source pins 402. In some embodiments, the set of source pins 402 corresponds to a set of display pixels 250 and a single capacitive sense element 320 shown in FIG. 3B. The method 500 includes forming (operation 504) each respective display pixel of the set of display pixels 250 coupled between a respective one of the plurality of display electrodes 214 (FIG. 2B) and the common electrode 128. The method 500 includes, at a first time to (e.g., associated with FIG. 4A), enabling (operation 506) a display driving state where each respective source pin 402 of the set of source pins 402 is configured to drive a distinct column of display electrodes 214 of the plurality of display electrodes, e.g., by driving a respective source line 304. The method 500 includes, at a second time t1 (e.g., associated with FIG. 4B), enabling (operation 508) a touch sensing state where a subset of the set of source pins 402 is configured to be electrically coupled to the common electrode 128 of the capacitive sense element 320, e.g., via a common electrode line 306.

It should be understood that the particular order in which the operations in FIG. 10 have been described is merely exemplary and are not intended to indicate that the described order is the only order in which the operations could be performed. One of ordinary skill in the art would recognize various ways to reorder the operations described herein. It is also noted that more details on the method of detecting touch events using the display pixel array are explained above with reference to FIGS. 1-5. For brevity, these details are not repeated in the description herein.

Various examples of aspects of the disclosure are described as numbered clauses (1, 2, 3, etc.) for convenience. These are provided as examples, and do not limit the subject technology. Identifications of the figures and reference numbers are provided below merely as examples and for illustrative purposes, and the clauses are not limited by those identifications.

Clause 1. An electronic device, comprising: a display pixel array including a plurality of display electrodes and a common electrode, wherein the common electrode is configured to form a set of display pixels with the plurality of display electrodes and provide a touch sensor, and each respective display pixel of the set of display pixels is formed between a respective display electrode and the common electrode; and a set of source pins coupled to the set of display pixels, wherein: each respective source pin of the set of source pins is configured to drive a distinct column of display electrodes of the plurality of display electrodes while the electronic device is in a display drive state, and a subset of the set of source pins is configured to obtain a capacitive sense signal from the common electrode while the electronic device is in a touch sensing state.

Clause 2. The electronic device of clause 1, further comprising: a first switch coupled between a first source line corresponding to a first column of display electrodes and a first source pin of the subset of the set of source pins, the first switch configured to enable a first electrical coupling between the first source line and the first source pin in the display drive state and disable the first electrical coupling in the touch sensing state; and a second switch coupled between the common electrode and the first source pin, the second switch configured to disable a second electrical coupling between the common electrode and the first source pin in the display drive state and enable the second electrical coupling in the touch sensing state.

Clause 3. The electronic device of clause 2, wherein each of the first switch and the second switch includes a thin film transistor (TFT) device.

Clause 4. The electronic device of clause 2 or 3, further comprising a source driver coupled to the first source pin, wherein the source driver is configured to generate a source drive voltage to drive the first column of display electrodes of the plurality of display electrodes in the display drive state.

Clause 5. The electronic device of clause 4, further comprising: a touch sensor AFE coupled to the first source pin, wherein the touch sensor AFE is configured to obtain the capacitive sense signal from the common electrode via the first source pin in the touch sensing state; and a multiplexer coupled among the source driver, the touch sensor AFE, and the first source pin, and the multiplexer is configured to select the source driver in the display drive state and the touch sensor AFE in the touch sensing state.

Clause 6. The electronic device of any of clauses 1-5, further comprising a touch sensor AFE coupled to the subset of source pins, wherein the touch sensor AFE is configured to obtain the capacitive sense signal from the common electrode via the subset of source pins and process the capacitive sense signal in the touch sensing state.

Clause 7. The electronic device of any of clauses 1-6, further comprising: a system common pin, wherein the system common pin is configured to drive the common electrode in the display drive state, and to provide a touch shield signal to the set of display pixels at the touch sensing state. In some embodiments, the shield signal is configured to reduce a parasitic load on the panel.

Clause 8. The electronic device of any of clauses 1-7, wherein the display pixel array is configured to alternate between the display driving state and the touch sensing state according to a predetermined duty cycle for the display driving state.

Clause 9. The electronic device of clause 8, wherein the predetermined duty cycle for the display drive state includes a first duty cycle, and the touch sensing state has a second duty cycle different than the first duty cycle.

Clause 10. The electronic device of clause 9, wherein the display pixel array is configured to have a display refresh rate during the first duty cycle and a touch sensing refresh rate during the second duty cycle, and the display refresh rate is greater than the touch sensing refresh rate.

Clause 11. The electronic device of any of clauses 1-10, wherein the touch sensing state corresponds to a touch sensing refresh rate between 40 and 80 Hertz, and the display drive state corresponds to a display refresh rate between 200 and 300 Hertz.

Clause 12. The electronic device of any of clauses 1-11, wherein the set of source pins comprises less than 1600 source pins. In other words, the pin limitation for producing a particular display resolution is lower than a conventional system that does not utilize the multi-function source pins described in this application.

Clause 13. The electronic device of any of clauses 1-12, wherein a first dimension of the common electrode has a size between 3 to 5 millimeters, and the common electrode corresponds to the set of source pins including 30 to 50 source pins.

Clause 14. The electronic device of any of clauses 1-13, wherein the set of source pins of the display pixel array has a pin pitch of 30-50 micrometers.

Clause 15. The electronic device of any of clauses 1-14, wherein each of the plurality of display electrodes and the common electrode is disposed on a respective indium-tin-oxide (ITO) panel.

Clause 16. The electronic device of clause 15, wherein: the display pixel array includes a plurality of layers of metallic materials for providing a plurality of source lines, a plurality of gate lines, and a plurality of common electrode lines, respectively; each display pixel includes a pixel TFT device coupled to a respective source line, a respective gate line, and the respective display electrode.

Clause 17. The electronic device of any of clauses 1-16, wherein for each respective display pixel, the respective display electrode and the common electrode forms a respective pixel capacitor that is charged in the display drive state, when the respective display electrode is driven by a source drive voltage provided via a respective source pin and the common electrode is drive by a pixel reference voltage provided via a system common pin.

Clause 18. The electronic device of any of clauses 1-17, wherein the set of source pins are located in proximity to one or more edges of the display pixel array.

Clause 19. The electronic device of any of clauses 1-18, further comprising a processing component coupled to the display pixel array, wherein the processing component is configured to drive the plurality of display electrodes and process the capacitive sense signal, and formed on a first substrate that is distinct from a second substrate of the display pixel array.

It will be understood that, although the terms first, second, etc. are, in some instances, used herein to describe various elements, these elements should not be limited by these terms. These terms are only used to distinguish one element from another. For example, a first voltage could be termed a second voltage, and, similarly, a second voltage could be termed a first voltage, without departing from the scope of the various described implementations. The first voltage and the second voltage are both voltage levels, but they are not the same voltage level.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, steps, operations, elements, and/or components, but do not preclude the presence or addition of one or more other features, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

Although some of various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages could be implemented in hardware, firmware, software, or any combination thereof.

The above description, for purpose of explanation, has been described with reference to specific implementations. However, the illustrative discussions above are not intended to be exhaustive or to limit the scope of the claims to the precise forms disclosed. Many modifications and variations are possible in view of the above teachings. The implementations were chosen in order to best explain the principles underlying the claims and their practical applications, to thereby enable others skilled in the art to best use the implementations with various modifications as are suited to the particular uses contemplated.

1. An electronic device, comprising:
a plurality of display electrodes;
a common electrode;
a display pixel array further including a set of display pixels, wherein each respective display pixel of the set of display pixels is disposed between a respective one of the plurality of display electrodes and the common electrode; and
a set of source pins coupled to the set of display pixels, a source driver configured to drive the plurality of display electrodes; and
a touch sensor analog front end (AFE) configured to obtain a capacitive sense signal from the common electrode; and
a multiplexer coupled to a first source pin of the set of source pins, the source driver, and the touch sensor AFE, wherein:
each respective source pin of the set of source pins is configured to drive a distinct column of display electrodes of the plurality of display electrodes while the electronic device is in a display driving state,
a subset of the set of source pins is configured to be electrically coupled to the common electrode while the electronic device is in a touch sensing state, and
the multiplexer is configured to select the source driver to be coupled to the first source pin in the display driving state and select the touch sensor AFE to be coupled to the first source pin in the touch sensing state.

2. The electronic device of claim 1, further comprising:
a first switch configured to enable a first source line corresponding to a first column of display electrodes to be electrically coupled to a first source pin in the display driving state and disable the first source line from being electrically coupled to the first source pin in the touch sensing state; and
a second switch configured to disable the common electrode from being electrically coupled to the first source pin in the display driving state and enable the common electrode to be electrically coupled to the first source pin in the touch sensing state.

3. The electronic device of claim 2, wherein each of the first switch and the second switch includes a thin film transistor (TFT) device.

4. The electronic device of claim 2, wherein a touch sensor analog front end (AFE) is configured to be coupled to the first source pin while the electronic device is in the touch sensing state.

5. The electronic device of claim 1, further comprising:
a system common pin, wherein the system common pin is configured to be electrically coupled to the common electrode in the display drive state, and to the plurality of display electrodes at the touch sensing state.

6. The electronic device of claim 1, wherein:
the display pixel array is configured to alternate between the display driving state and the touch sensing state according to a predetermined duty cycle for the display driving state, thereby detecting a contact with or in proximity to a touch sensor that is electrically coupled with the display pixel array without interfering with display operations of the display pixel array.

7. The electronic device of claim 6, wherein:
The predetermined duty cycle for the display driving state is a first duty cycle, and
the touch sensing state has a second duty cycle, different than the first duty cycle.

8. The electronic device of claim 7, wherein the display pixel array is configured to having a higher refresh rate during the first duty cycle than during the second duty cycle.

9. The electronic device of claim 1, wherein the set of source pins is configured to provide a shield signal while the electronic device is in the touch sensing state.

10. The electronic device of claim 1, wherein the plurality of display electrodes and the common electrode are disposed on an indium-tin-oxide (ITO) panel.

11. The electronic device of claim 10, wherein:
the ITO panel further includes a plurality of layers of metallic materials, and
at least one of the plurality of layers of metallic materials comprises a plurality of TFT switches configured to couple to the set of source pins.

12. The electronic device of claim 1, wherein:
the display pixel array includes a plurality of layers of metallic materials for providing a plurality of source lines, a plurality of gate lines, and a plurality of common electrode lines, respectively; and
each display pixel includes a pixel TFT device coupled to a respective source line, a respective gate line, and the respective display electrode

13. The electronic device of claim 1, wherein for each respective display pixel, the respective display electrode and the common electrode forms a respective pixel capacitor that is charged in the display drive state, when the respective display electrode is driven by a source drive voltage provided via a respective source pin and the common electrode is driven by a pixel reference voltage provided via a system common pin.

14. The electronic device of claim 1, wherein the subset of the set of source pins is configured to obtain a capacitive sense signal from the common electrode while the electronic device is in the touch sensing state, and the electronic device further comprising:
a processing component coupled to the display pixel array, wherein the processing component is configured to drive the plurality of display electrodes and process the capacitive sense signal, and formed on a first substrate that is distinct from a second substrate of the display pixel array.

15. The electronic device of claim 1, where the set of source pins is disposed in proximity to one or more edges of the display pixel array.

16. A method, comprising:
at an electronic device comprising (i) a plurality of display electrodes, (ii) a common electrode configured to provide touch sensing capabilities, (iii) a display pixel array further including a set of display pixels, (iv) a set of source pins coupled to the set of display pixels, (v) a source driver configured to drive the plurality of display electrodes, (vi) a touch sensor analog front end (AFE) configured to obtain a capacitive sense signal from the common electrode, and (vii) a multiplexer coupled to a first source pin of the set of source pins, the source driver, and the touch sensor AFE, wherein each respective display pixel of the set of display pixels is disposed between a respective one of the plurality of display electrodes and the common electrode:
at a first time, enabling a display driving state where each respective source pin of the set of source pins is configured to drive a distinct column of display electrodes of the plurality of display electrodes,
at a second time, enabling a touch sensing state where a subset of the same set of source pins is configured to be electrically coupled to the common electrode, and
the multiplexer is configured to select the source driver to be coupled to the first source pin in the display driving state and select the touch sensor AFE to be coupled to the first source pin in the touch sensing state.

17. A touch sensing system, comprising:
a plurality of display electrodes;
a common electrode,
a display pixel array further including a set of display pixels, wherein each respective display pixel of the set of display pixels is disposed between a respective one of the plurality of display electrodes and the common electrode; and
a set of source pins coupled to the set of display pixels, a source driver configured to drive the plurality of display electrodes;
a touch sensor analog front end (AFE) configured to obtain a capacitive sense signal from the common electrode; and
a multiplexer coupled to a first source pin of the set of source pins, the source driver, and the touch sensor AFE, wherein:
each respective source pin of the set of source pins is configured to drive a distinct column of display electrodes of the plurality of display electrodes while the touch sensing system is in a display driving state,
a subset of the same set of source pins configured to be electrically coupled to the common electrode while the touch sensing system is in a touch sensing state, and
the multiplexer is configured to select the source driver to be coupled to the first source pin in the display driving state and select the touch sensor AFE to be coupled to the first source pin in the touch sensing state.

18. The touch sensing system of claim 17, further comprising a switch component, wherein the switch component is configured to:
in the display driving state, enable a first source line corresponding to a first column of display electrodes to be electrically coupled to a first source pin, and enable the common electrode to be electrically coupled to a system common pin; and
in the touch sensing state, enable the common electrode to be electrically coupled to the first source pin, and enable the first source line to be electrically coupled to the system common pin.

19. The touch sensing system of claim 18, wherein the switch component includes a thin film transistor (TFT) device.

20. The touch sensing system of claim 17, wherein the subset of the set of source pins is configured to obtain a capacitive sense signal from the common electrode while the touch sensing system is in the touch sensing state, and the touch sensing system further comprising:
a processing component coupled to the display pixel array, wherein the processing component is configured to drive the plurality of display electrodes and process the capacitive sense signal, and formed on a first substrate that is distinct from a second substrate of the display pixel array.
